(19) United States
(12) Patent Application Publication
(10) Pub. No.: US 2020/0349576 A1
(43) Pub. Date: Nov. 5, 2020

(54) ANOMALY IDENTIFICATION FOR FRAUD DETECTION

(71) Applicant: Walmart Apollo, LLC, Bentonville, AR (US)

(72) Inventor: Somedip Karmakar, Kolkata (IN)

(21) Appl. No.: 16/442,525

(22) Filed: Jun. 16, 2019

(30) Foreign Application Priority Data
May 3, 2019 (IN) 201941017685

(51) Int. Cl. G06Q 20/40; G06N 20/00

(52) U.S. Cl. CPC G06Q 20/4016; G06F 17/18; G06N 20/00; G06Q 20/407

(57) ABSTRACT

The disclosed anomaly identification tool for fraud detection provides a data-driven method to identify potential fraud cases and includes receiving sales and refund data from transaction nodes, determining a plurality of metric data sets, for example return amount, return frequency, and return rate; and determining statistical distributions for the metrics. Risk thresholds can be set for identifying anomalous transactions, based on the metric statistics, which can be used as triggers for reporting risk or detection of potentially fraudulent transactions. Data analytics is thus leveraged, and can be applied at different levels and contexts of enterprise activity, for example by regions, by product line, and down to more focused areas such as specific retail channels. Some examples are able to identify anomalous activity indicative of collusion in fraudulent transactions.

### BACKGROUND

In large-scale, complex e-commerce operations, it may be possible for fraud to occur and remain undetected, without proper analysis and investigation tools and resources. Various types of e-commerce fraud can occur, such as requesting a refund for items that were received intact while claiming the items had been lost or damaged, returning items purchased at a discount while demanding a refund on the higher list price, and other examples. In some scenarios, thoroughly investigating every refund or return transaction can become prohibitively burdensome. Therefore, data analytics tools are needed that can identify indications of fraudulent transactions.

### SUMMARY

A disclosed anomaly identification tool for fraud detection provides a data-driven method to identify potential fraud cases and comprises: a first transaction node; a second transaction node; a processor; and a computer-readable medium storing instructions that are operative when executed by the processor to: receive sales data from at least the first transaction node, the sales data indexed with one of a plurality of customer IDs; receive refund data from at least the second transaction node, the refund data indexed with one of the plurality of customer IDs; determine, based at least on the sales data and the refund data, a plurality of metric data sets indexed with one of the plurality of customer IDs, wherein the plurality of metric data sets includes at least a return amount data set, a return frequency data set, and a return rate data set; determine a plurality of statistical distributions for the plurality of metric data sets, wherein the return amount data set, the return frequency data set, and the return rate data set are each fit to a different statistical distribution; determine, for each of the plurality of statistical distributions, a risk threshold to produce a plurality of risk thresholds; determine, for each selected customer ID within the plurality of customer IDs and based at least on the plurality of risk thresholds, whether at least one metric value from the plurality of metric data sets, indexed with the selected customer ID, meets a corresponding risk threshold; and based at least on the metric value indexed with the selected customer ID meeting the corresponding risk threshold, report a risk transaction.

### BRIEF DESCRIPTION OF THE DRAWINGS

The disclosed examples are described in detail below with reference to the accompanying drawing figures listed below:

FIG. 1 illustrates an exemplary environment that can advantageously employ e-commerce anomaly identification for fraud detection;

FIG. 2 is a block diagram of exemplary components that can perform anomaly identification for fraud detection;

FIG. 3 illustrates exemplary metric data used in anomaly identification for fraud detection;

FIG. 4 illustrates additional exemplary data used in anomaly identification for fraud detection;

FIG. 5 illustrates additional exemplary data used in anomaly identification for fraud detection;

FIG. 6A illustrates additional exemplary data used in anomaly identification for fraud detection;

FIG. 6B illustrates additional exemplary data used in anomaly identification for fraud detection;

FIG. 6C illustrates additional exemplary data used in anomaly identification for fraud detection;

FIG. 7A illustrates a exemplary probability density function that can be used to model some of the data used in anomaly identification for fraud detection;

FIG. 7B illustrates another exemplary probability density function that can be used to model some of the data used in anomaly identification for fraud detection;

FIG. 7C illustrates another exemplary probability density function that can be used to model some of the data used in anomaly identification for fraud detection;

FIG. 8 shows a flow chart of operations associated with e-commerce anomaly identification for fraud detection; and

FIG. 9 is a block diagram of an example computing node for implementing aspects disclosed herein.

Corresponding reference characters indicate corresponding parts throughout the drawings. Elements in the figures are illustrated for simplicity and clarity and have not necessarily been drawn to scale. For example, the dimensions and/or relative positioning of some of the elements in the figures may be exaggerated relative to other elements to help to improve understanding. Also, common but well-understood elements that are useful or necessary in a commercially feasible embodiment may not be depicted, in order to facilitate a less obstructed view.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity, this implied leading clause is not repeated ad nauseum.

In large-scale, complex e-commerce operations, it may be possible for fraud to occur and remain undetected, without proper analysis and investigation tools and resources. Various types of e-commerce fraud can occur, such as requesting a refund for items that were received intact while claiming the items had been lost or damaged, returning items purchased at a discount while demanding a refund on the higher list price, and other examples. In some scenarios, thoroughly investigating every refund or return transaction can become prohibitively burdensome. Therefore, data analytics tools are needed that can identify indications of fraudulent transactions.

The disclosed anomaly identification tool for fraud detection provides a data-driven method to identify potential fraud cases and includes receiving sales and refund data from transaction nodes, determining a plurality of metric data sets, for example return amount, return frequency, and return rate; and determining statistical distributions for the metrics. Risk thresholds can be set for identifying anomalous transactions, based on the metric statistics, which can be used as triggers for reporting risk or detection of potentially fraudulent transactions. Data analytics is thus leveraged, and can be applied at different levels and contexts of enterprise activity, for example by regions, by product line, and down to more focused areas such as specific retail channels. Some examples are able to identify anomalous activity indicative of collusion in fraudulent transactions.

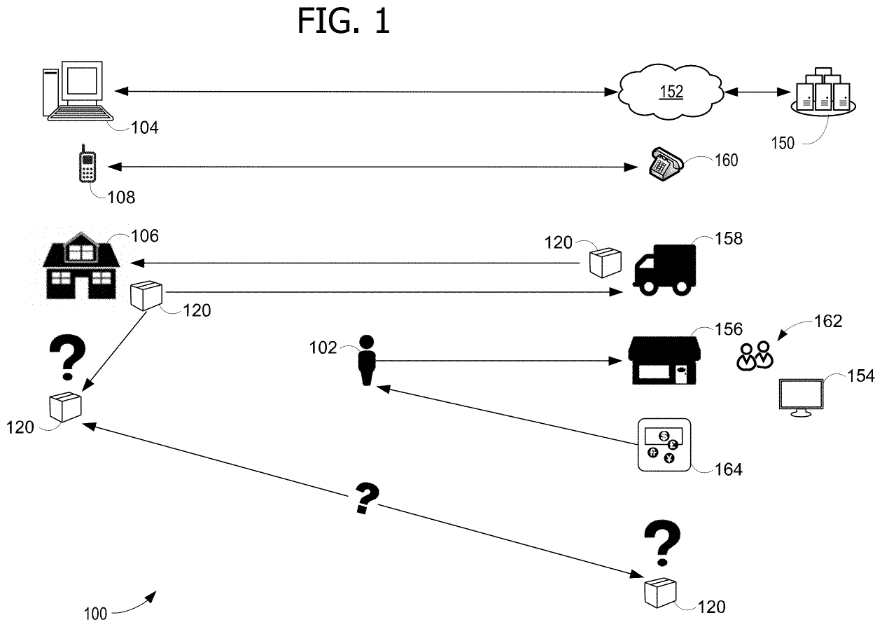

FIG. 1 illustrates an exemplary environment 100 that can advantageously employ e-commerce anomaly identification for fraud detection. A customer 102 orders some items in an e-commerce sales transaction, for example by using a computer 104 visiting an online sales site 150 (e.g., a website) over the internet 152, or using an in-store terminal 154 in a retail facility 156. In some situations, a delivery vehicle 158 delivers goods 120 (at least some of the ordered items) to customer location 106 (e.g., a residence or office). Each of delivery vehicle 158, online sales site 150, and in-store terminal 154 acts as a sales transaction node, because each can take part in a sales transaction and/or be a source of information. For example, delivery vehicle 158 (or equipment thereon) may collect an electronic record of deliveries and retrievals. Alternatively, customer 102 can elect to forego delivery to customer location 106 and pick up goods 120 at retail facility 156.

Customer 102 then demands a refund for goods 120. This may occur in one of multiple ways. Customer 102 can use computer 104 to visit online sales site 150 or call in to call center 160 with telephone 108. In some cases, customer can refuse delivery when delivery vehicle 158 arrives to deliver goods 120, or even schedule delivery vehicle 158 to retrieve goods 120 that had been delivered earlier. For in-store pickups, customer 102 can cancel the order, for example with the assistance of sales representatives 162 who may enter the cancellation into in-store terminal 154. In some situations, orders are canceled prior to pickup of goods 120. However, in other situations, an order is not canceled until after pickup of goods 120. Each of delivery vehicle 158, online sales site 150, and in-store terminal 154 acts as a refund transaction node, because each can take part in a refund transaction and/or be a source of information.

Customer 102 then receives a refund 164. However, there is a possibility that refund 164 is part of a fraudulent transaction. For example, if goods 120 were not returned (e.g., customer 102 claims goods 120 had not been delivered or were damaged and discarded), but yet customer does possess goods 120 in good condition, then refund 164 is unwarranted. Alternatively, refund 164 may be more than customer 102 had paid. In some cases, items returned may be counterfeit, such as if customer had purchased lower quality items elsewhere and represented them as goods 120. A refund analysis can identify anomalous transactions and high-risk transactions, such as high refund request amounts or frequency, demanding a refund without returning goods, and canceling orders after item pickup.

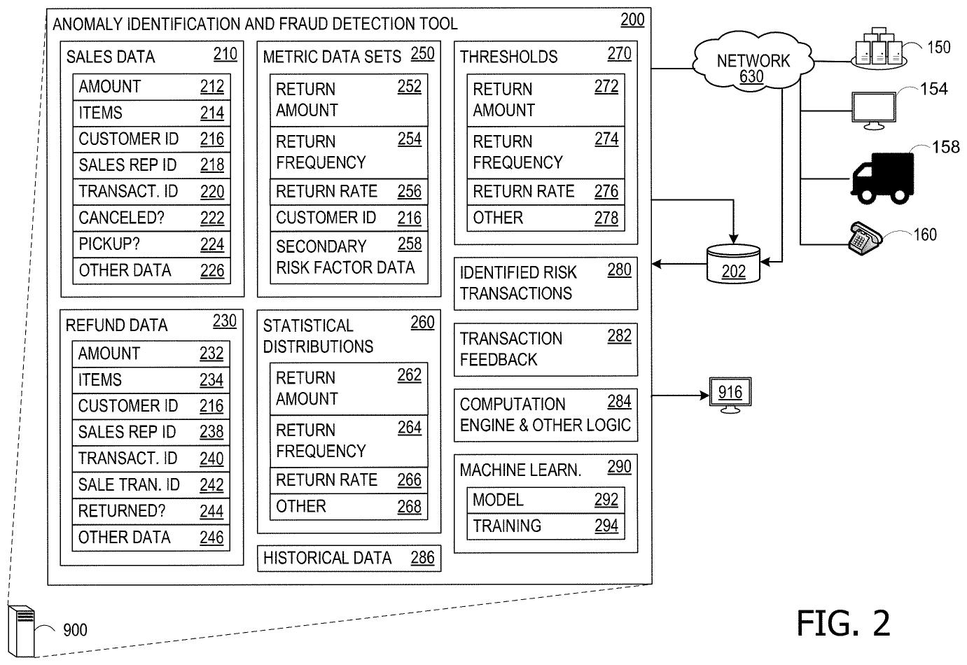

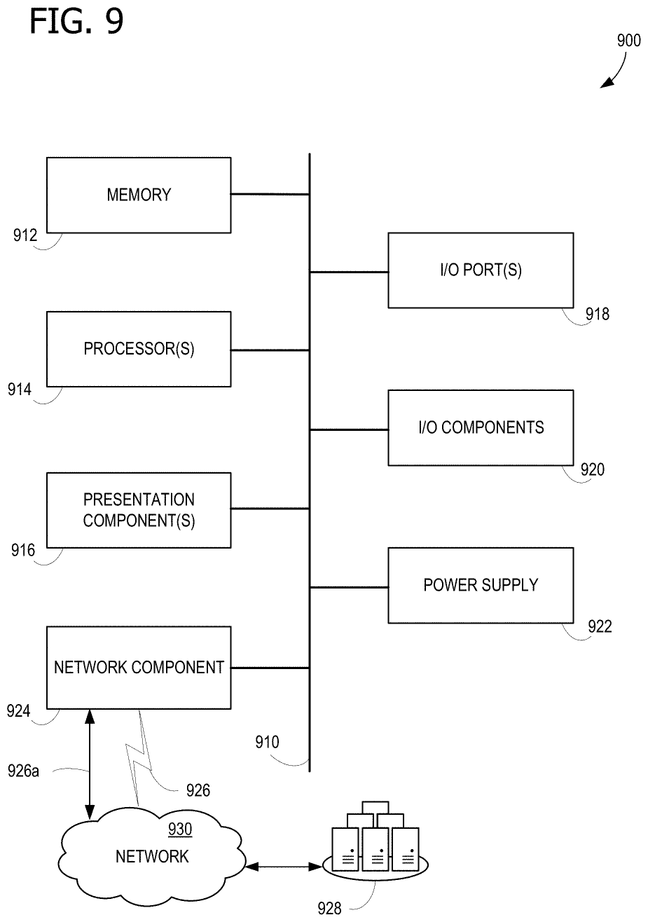

FIG. 2 shows an anomaly identification and fraud detection tool 200 that can perform operations described herein to detect fraud-related anomalies for e-commerce transactions. In some examples, the operations described herein for anomaly identification and fraud detection tool 200 are performed as computer-executable instructions on one or more computing nodes 900 (which is described in more detail in relation to FIG. 9), using the data sets described herein, that are stored on one or more computing nodes 900.

Anomaly identification and fraud detection tool 200 connects to online sales site 150, in-store terminal 154, delivery vehicle 158, and call center 160 over network 630 (collectively, transaction nodes) to receive and store sales data 210 and refund data 230 locally and/or in a data store 202. Sales data 210 is indexed with one of a plurality of customer IDs 216 and also includes amounts 212, item lists 214 (e.g., items sold), sales representative IDs 218, transaction IDs 220, cancellation flags 222 (indicating whether an order was canceled), pickup flags 224 (indicating whether goods for an order was picked up), and other data 226, such as a retail facility ID, and other information. Refund data 230 is also indexed with one of the plurality of customer IDs 216, and has similar information: Amounts 232, item lists 234 (e.g., items refunded), sales representative IDs 238, transaction IDs 240, links 242 to the corresponding transaction IDs 220 in sales data 210, return flags 244 (indicating whether the goods were returned), and other data 246, such as a retail facility ID, and other information.

A computation engine 284 performs computations described herein, such as determining, based at least on sales data 210 and refund data 230, a plurality of metric data sets 250 indexed with one of the plurality of customer IDs 216, wherein plurality of metric data sets 250 includes at least a return amount data set 252, a return frequency data set 254, and a return rate data set 256. Return amount data set 252 is derived from amounts 232 in refund data 230. Return frequency data set 254 leverages historical data 286, that stores information so that return histories can be ascertained by customer IDs 216. Return rate data set 256 is derived using amounts 212 in sales data 210 and amounts 232 in refund data 230, to reflect the rate at which purchases that are refunded. Secondary risk factor data 258 is used for calculating additional risk metric data, such as for identifying retail facilities and sales representatives associated with higher (and potentially anomalous) refund activity.

Computation engine 284 also determines a plurality of statistical distributions 260 for plurality of metric data sets 250, wherein return amount data set 252, return frequency data set 254, and return rate data set 256 are each fit to a different statistical distribution 262, 264, or 266, respectively. In some examples, return amount data set 252 is fit to an exponential distribution 262. In some examples, return frequency data set 254 is fit to a Poisson distribution 264. In some examples, return rate data set 256 is fit to a beta distribution 266. In some examples, other statistical distributions 268 are also generated (fit). Computation engine 284 then determines, for each of the plurality of statistical distributions 260, a risk threshold to produce a plurality of risk thresholds 270. Risk thresholds 270 include return amount risk threshold 272, return frequency risk threshold 274, and return rate risk threshold 276. In some examples, other risk thresholds 278 are also determined. In some examples, secondary risk factor data 258 is used in determining risk thresholds 270. In some examples, a machine learning (ML) model 292 (in ML component 290) is used in determining risk thresholds 270. Because some parameters are affected by time, such as the total amount of returns processed within some period, risk thresholds 270 can vary based on the time period covered by the data.

Next, computation engine 284 determines, based at least on plurality of risk thresholds 270, whether at least one metric value from the plurality of metric data sets 250, indexed with the selected customer ID 216, meets a corresponding risk threshold (in one of return amount risk threshold 272, return frequency risk threshold 274, and return rate risk threshold 276). Based at least on the metric value indexed with the selected customer ID 216 meeting the corresponding risk threshold, a risk transaction is identified. Identified risk transactions 280 are stored and reported, for example using presentation components 916 (e.g., a computer monitor screen) or another outgoing message. In some examples, reporting a risk transaction includes writing a file to memory for later retrieval. In some examples, reporting a risk transaction includes sending an electronic message. In some examples, reporting a risk transaction includes reporting the customer ID as a risk customer.

Upon an investigation (triggered by the reporting) the finding may be that the risk transactions included fraud, or were legitimate. This information is saved in transaction feedback data 282. ML component 290 then uses ML training component 294 on transaction feedback data 282 to train Ml model 292.

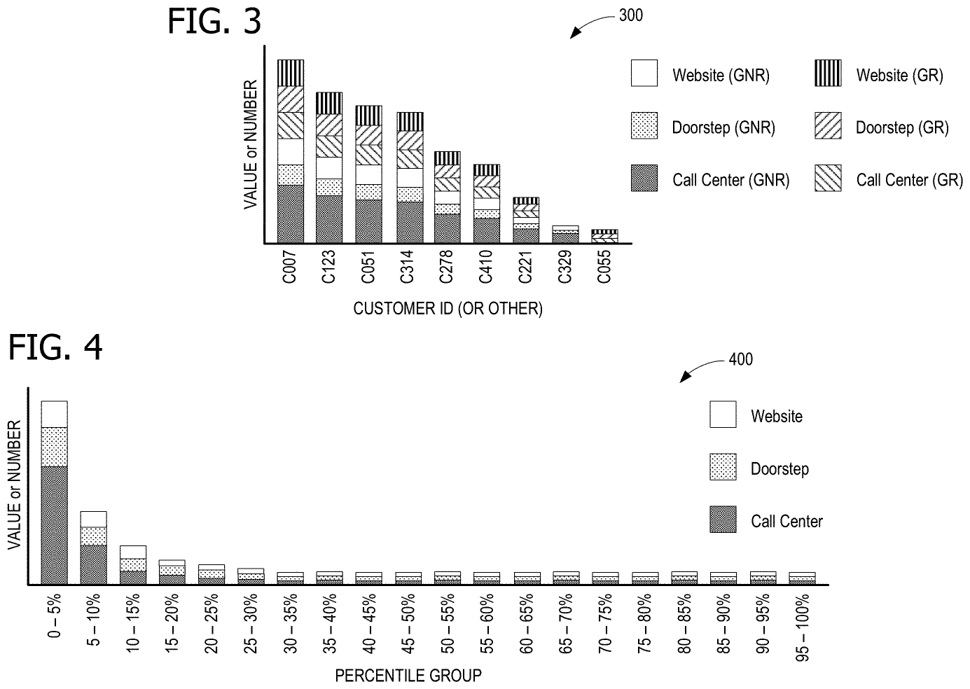

FIG. 3 illustrates exemplary metric data used in anomaly identification for fraud detection in a bar graph 300. Specifically, bar graph 300 illustrates return transaction for various customer IDs, noting whether the return is accomplished using a website (online sales site 150), at the customer's doorstep (via delivery vehicle 158), or a call center (call center 160), and whether the goods are returned (GR) or not returned (GNR). Customers demanding refunds when goods are not returned may claim that the goods were lost or damaged and discarded. Other return options could also be tracked, beyond those illustrated. The heights of the bars can correspond to any of the value of the returns, the number of items returned, the number of return transactions, or another metric. In some examples, the location of a transaction is a secondary risk factor in determination of a risk threshold, and so a version of bar graph 300 is created, indexed by location, rather than customer ID. Locations tracked can vary from individual retail outlets to geographic regions. In some examples, an item included in a transaction is a secondary risk factor in determination of a risk threshold, and so a version of bar graph 300 is created, indexed by item code or department.

FIG. 4 illustrates a histogram 400 of return transactions grouped by customer percentile. The generation of histogram 400 follows this process: Return transactions are aggregated by customer ID, noting whether the return is accomplished using a website, a delivery driver, or a call center. Other return options could also be tracked, beyond those illustrated. The customer IDs are ranked by any of the value of the returns, the number of items returned, or the number of return transactions. The ranked set is binned into percentile groups as shown. Within each percentile group, the return options are summed, and the totals are used to determine the bar heights for each percentile group.

As indicated, in FIG. 4, a relatively small group, comprising only 5% of the total number of customer IDs, is responsible for a disproportionate amount of return transactions (per the ranking criteria). One interpretation of histogram 400 is that most customers do not return high amounts, and if they do, returns are infrequent or a small amount of the purchases. In some examples, the location of a transaction is a secondary risk factor in determination of a risk threshold, and so a version of histogram 400 is created, indexed by location, rather than customer ID.

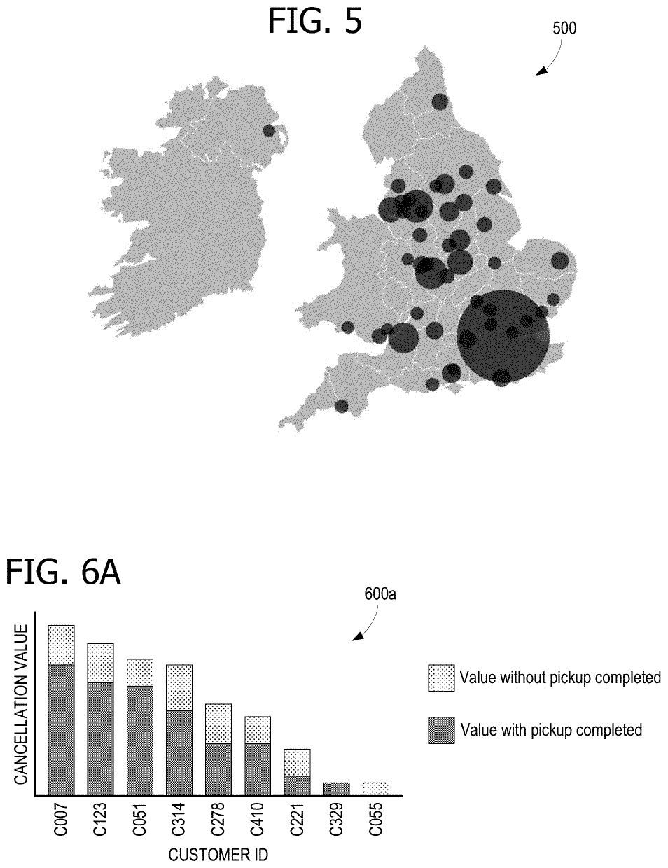

FIG. 5 illustrates a display of transaction location information as a map 500. In some examples, the location of a transaction is a secondary risk factor in determination of a risk threshold. Map 500 illustrates risks or certain risk metrics as circles, centered at the location of a particular retail facility or a representative regional reference point, with the diameter of each circle proportionate to the value of the metric. Metrics that can be displayed for the particular facility this way, by the anomaly identification and fraud detection tool 200, include values of sales, returns, and cancellations; item counts for sales, returns, and cancellations; rates of sales, returns, and cancellations; frequencies of returns and cancellations; and other metrics. In some examples, the circles can represent multiple values simultaneously, one by circle diameter, and another by shading intensity.

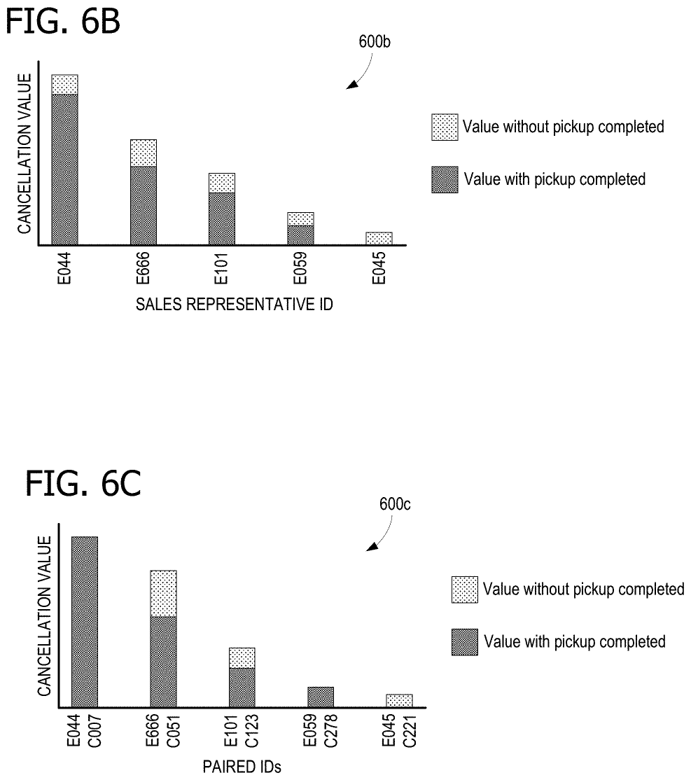

FIG. 6A illustrates additional exemplary data used in anomaly identification for fraud detection in a bar graph 600a. Specifically, bar graph 600a illustrates transaction data for canceled transactions for various customer IDs. That is, the data graphed in bar graph 600a is indexed with one of a plurality of customer IDs. In some order cancellation transactions, the cancellation occurs after item pickup has been completed. This is shown in the darkly shaded portion of the bars. In some order cancellation transactions, the cancellation occurs prior to item pickup. This is shown in the lightly shaded portion of the bars.

Because some transaction data includes both customer information and information indicating the sales representative who had been assisting the customer with the transaction, it is possible to generate a similar bar graph for sales representatives. In some examples, a sales representative associated with a transaction is a secondary risk factor in determination of a risk threshold. Thus, bar graph 600b of FIG. 6B illustrates transaction data for canceled transactions, indexed with one of a plurality of sales representative IDs. The shading of the bars, indicating transaction value without pickup and transaction value with pickup is consistent with FIG. 6A. The sales representatives represented in bar graph 600b may be sales representatives working within a retail facility, call center sales representatives, or delivery drivers.

Correlating the customer IDs and sales representative IDs permits identification of potential collusion. In some examples, the pairing of a particular customer and a sales representative associated with a transaction is a secondary risk factor in determination of a risk threshold. Thus, FIG. 6C illustrates transaction data for canceled transactions, indexed with paired sets of sales representative IDs and customer IDs in bar graph 600c. This enables identification of customers having an “inside contact” who assists with fraudulent transactions. In some examples, collusions can also be detected by location, when a particular sales representative, who colludes with one or more customers, remains predominantly at a single retail facility.

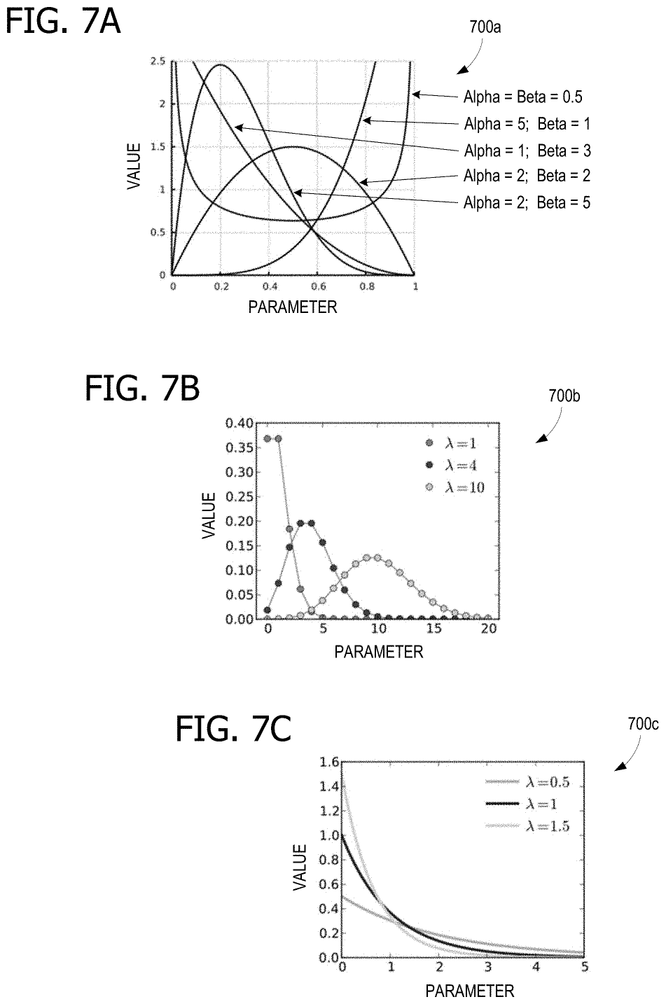

FIGS. 7A-7C illustrate probability density functions that can be used to model some of the data used in anomaly identification for fraud detection. FIG. 7A is a plot 700a of various curves, for different parameters, of the well-known beta probability distribution function. In some examples, the return rate data set is fit to a beta distribution. The beta distribution is a family of continuous probability distributions defined on the interval [0, 1] and parametrized by two positive shape parameters, denoted by alpha and beta, that appear as exponents of the random variable and control the shape of the distribution.

FIG. 7B is a plot 700b of various curves, for different parameters, of the well-known Poisson probability distribution function. In some examples, the return frequency data set is fit to a Poisson distribution. The Poisson distribution is a discrete probability distribution that expresses the probability of a given number of events occurring in a fixed interval of time or space if these events occur with a known constant rate and independently of the time since the last event. FIG. 7C is a plot 700c of various curves, for different parameters, of the well-known exponential probability distribution function. In some examples, the return amount data set is fit to an exponential distribution. The exponential distribution describes the time between events in a Poisson process (e.g., a process in which events occur continuously and independently at a constant average rate).

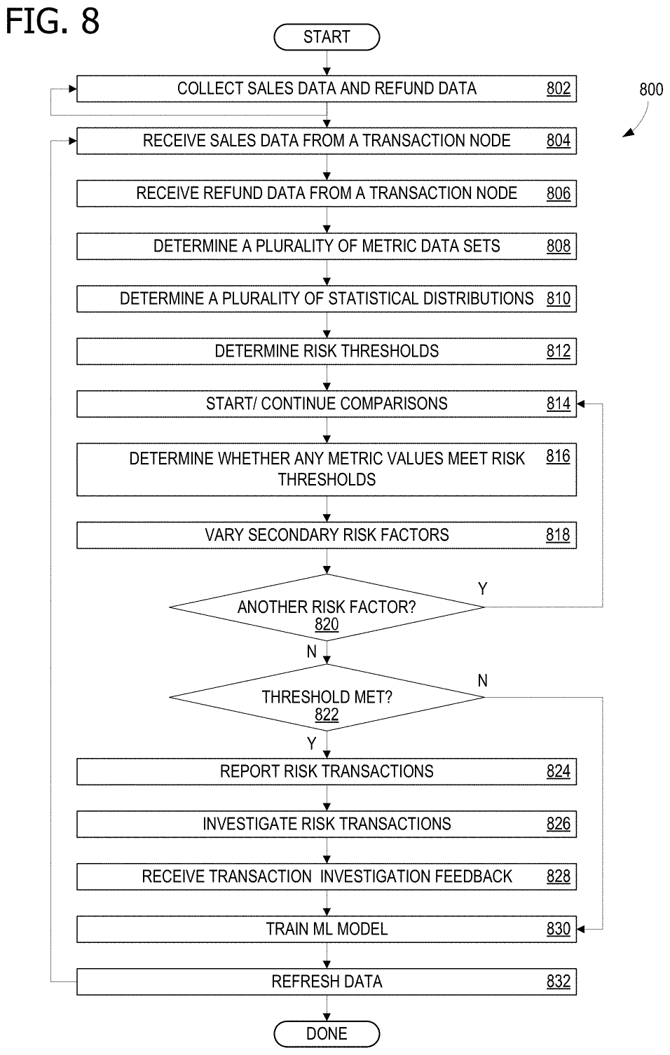

FIG. 8 shows a flow chart 800 of exemplary operations associated with e-commerce anomaly identification for fraud detection. In some examples, some or all of flow chart 800 is performed as computer-executable instructions on a computing node 900 (see FIG. 9). Flow chart 800 commences with operation 802, which includes collecting sales data and refund data into a data store. Operation 802 is ongoing, as transactions occur. Operation 804 includes receiving sales data from at least a first transaction node, the sales data indexed with one of a plurality of customer IDs. In some examples, the data is held in a data store in intervening time periods between transactions being recoded at a transaction node, and the analytics operations of flow chart 800. In some examples, the first transaction node comprises at least one node selected from the list consisting of: a delivery vehicle, an online sales site, and an in-store terminal. Operation 806 includes receiving refund data from at least a second transaction node, the refund data indexed with one of the plurality of customer IDs. In some examples, the second transaction node comprises at least one node selected from the list consisting of: a delivery vehicle, an online sales site, and an in-store terminal.

Operation 808 includes determining, based at least on the sales data and the refund data, a plurality of metric data sets indexed with one of the plurality of customer IDs, wherein the plurality of metric data sets includes at least a return amount data set, a return frequency data set, and a return rate data set. Operation 810 then includes determining a plurality of statistical distributions for the plurality of metric data sets, wherein the return amount data set, the return frequency data set, and the return rate data set are each fit to a different statistical distribution. In some examples, the return amount data set is fit to an exponential distribution. In some examples, the return frequency data set is fit to a Poisson distribution. In some examples, the return rate data set is fit to a beta distribution. Statistical distributions are created for various scopes of the data analytics, such as enterprise wide, specific markets (e.g., countries, regions), by specific sales channels (e.g., websites, retail facilities), by home delivery region or route, by department (e.g., clothing, electronics), by item type (televisions, purses), or by some other category.

Operation 812 includes determining, for each of the plurality of statistical distributions, a risk threshold to produce a plurality of risk thresholds. In some examples, determining the risk threshold comprises determining, based on a secondary risk factor, the risk threshold, wherein the secondary risk factor comprises at least one factor selected from the list consisting of: a location of a transaction, a sales representative associated with a transaction, and an item included in a transaction. In some examples, determining the risk threshold for each of the plurality of statistical distributions comprises determining, using an ML model, the threshold for each of the plurality of statistical distributions.

Comparisons between metric values and thresholds are then initiated in operation 814. Operation 816 includes determining, for each selected customer ID within the plurality of customer IDs and based at least on the plurality of risk thresholds, whether at least one metric value from the plurality of metric data sets, indexed with the selected customer ID, meets a corresponding risk threshold. Risk factors are varied in operation 818, for example to include the effects of secondary risk factors, such as specific retail facilities or sales representatives, or items. Decision operation 820 loops back to operation 814, if more thresholds and metrics are to be compared.

If, according to decision operation 822 a risk threshold was met, then operation 824 includes, based at least on the metric value indexed with the selected customer ID meeting the corresponding risk threshold, reporting a risk transaction. In some examples, this is reporting the customer ID as a risk customer. Transactions identified as risk transactions (suspected fraud transactions) are investigated in operation 826, and the results of the investigations are received as transaction feedback in operation 828. The results can include a determination that the investigated transaction was fraudulent or was legitimate. This can be used to train the ML model used in operation 812 to determine risk thresholds. Therefore, operation 830 includes training the ML model on transaction feedback data.

Flow chart 800 should be run for continual fraud monitoring when transactions are ongoing in operation 802. Therefore, operation 832 refreshes the metric data and repeats the foregoing, by returning to operation 804, for example weekly, or another time period, or based on events (e.g., holiday transaction surges). The metrics will contain time dependencies, so risk thresholds will be set according to the time period included within the metric data. For example, the risk threshold for the return amount metric will be different when time period included is a week versus two weeks.

### Exemplary Operating Environment

FIG. 9 is a block diagram of an example computing node 900 for implementing aspects disclosed herein and is designated generally as computing node 900. Computing node 900 is one example of a suitable computing environment and is not intended to suggest any limitation as to the scope of use or functionality of the invention. Neither should the computing node 900 be interpreted as having any dependency or requirement relating to any one or combination of components/modules illustrated. The examples and embodiments disclosed herein may be described in the general context of computer code or machine-usable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing nodes, etc. The disclosed examples may also be practiced in distributed computing environments, where tasks are performed by remote-processing devices that are linked through communications network 930.

Computing node 900 includes a bus 910 that directly or indirectly couples the following devices: memory 912, one or more processors 914, one or more presentation components 916, input/output (I/O) ports 918, I/O components 920, a power supply 922, and a network component 924. Computing node 900 should not be interpreted as having any dependency or requirement related to any single component or combination of components illustrated therein. While computing node 900 is depicted as a seemingly single device, multiple computing nodes 900 may work together and share the depicted device resources. That is, one or more computer storage devices having computer-executable instructions stored thereon may perform operations disclosed herein. For example, memory 912 may be distributed across multiple devices, processor(s) 914 may provide housed on different devices, and so on.

Bus 910 represents what may be one or more busses (such as an address bus, data bus, or a combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 9 is merely illustrative of an exemplary computing node that can be used in connection with one or more embodiments. Distinction is not made between such categories as “workstation,” “server,” “laptop,” “hand-held device,” etc., as all are contemplated within the scope of FIG. 9 and the references herein to a “computing node” or a “computing device.” Memory 912 may include any of the computer-readable media discussed herein. Memory 912 may be used to store and access instructions configured to carry out the various operations disclosed herein. In some examples, memory 912 includes computer storage media in the form of volatile and/or nonvolatile memory, removable or non-removable memory, data disks in virtual environments, or a combination thereof.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing node 900, or by a processor external to the client computing node 900. In some examples, the processor(s) 914 are programmed to execute instructions such as those illustrated in the flowcharts discussed below and depicted in the accompanying drawings. Moreover, in some examples, the processor(s) 914 represent an implementation of analog techniques to perform the operations described herein. For example, the operations may be performed by an analog client computing node 900 and/or a digital client computing node 900.

Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly among multiple computing nodes 900, across a wired connection, or in other ways. Ports 918 allow computing node 900 to be logically coupled to other devices including I/O components 920, some of which may be built in. Example I/O components 920 include, for example but without limitation, a microphone, keyboard, mouse, joystick, game pad, satellite dish, scanner, printer, wireless device, etc.

In some examples, the network component 924 includes a network interface card and/or computer-executable instructions (e.g., a driver) for operating the network interface card. Communication between the computing node 900 and other devices may occur using any protocol or mechanism over any wired or wireless connection. In some examples, the network component 924 is operable to communicate data over public, private, or hybrid (public and private) network 930 using a transfer protocol, between devices wirelessly using short range communication technologies (e.g., near-field communication (NFC), Bluetooth® branded communications, or the like), or a combination thereof. Network component 924 communicates over wireless communication link 926 and/or a wired communication link 926a to a cloud resource 928 across network 930. Various different examples of communication links 926 and 926a include a wireless connection, a wired connection, and/or a dedicated link, and in some examples, at least a portion is routed through the internet.

Although described in connection with an example computing node 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing nodes, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device or computing node when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for anomaly identification and fraud detection comprises: a first transaction node; a second transaction node; a processor; and a computer-readable medium storing instructions that are operative when executed by the processor to: receive sales data from at least the first transaction node, the sales data indexed with one of a plurality of customer IDs; receive refund data from at least the second transaction node, the refund data indexed with one of the plurality of customer IDs; determine, based at least on the sales data and the refund data, a plurality of metric data sets indexed with one of the plurality of customer IDs, wherein the plurality of metric data sets includes at least a return amount data set, a return frequency data set, and a return rate data set; determine a plurality of statistical distributions for the plurality of metric data sets, wherein the return amount data set, the return frequency data set, and the return rate data set are each fit to a different statistical distribution; determine, for each of the plurality of statistical distributions, a risk threshold to produce a plurality of risk thresholds; determine, for each selected customer ID within the plurality of customer IDs and based at least on the plurality of risk thresholds, whether at least one metric value from the plurality of metric data sets, indexed with the selected customer ID, meets a corresponding risk threshold; and based at least on the metric value indexed with the selected customer ID meeting the corresponding risk threshold, report a risk transaction.

An exemplary method of anomaly identification for fraud detection comprises: receiving sales data from at least a first transaction node, the sales data indexed with one of a plurality of customer IDs; receiving refund data from at least a second transaction node, the refund data indexed with one of the plurality of customer IDs; determining, based at least on the sales data and the refund data, a plurality of metric data sets indexed with one of the plurality of customer IDs, wherein the plurality of metric data sets includes at least a return amount data set, a return frequency data set, and a return rate data set; determining a plurality of statistical distributions for the plurality of metric data sets, wherein the return amount data set, the return frequency data set, and the return rate data set are each fit to a different statistical distribution; determining, for each of the plurality of statistical distributions, a risk threshold to produce a plurality of risk thresholds; determining, for each selected customer ID within the plurality of customer IDs and based at least on the plurality of risk thresholds, whether at least one metric value from the plurality of metric data sets, indexed with the selected customer ID, meets a corresponding risk threshold; and based at least on the metric value indexed with the selected customer ID meeting the corresponding risk threshold, reporting a risk transaction.

An exemplary computer storage device has computer-executable instructions stored thereon for anomaly identification and fraud detection, which, on execution by a computer, cause the computer to perform operations comprising: receiving sales data from at least a first transaction node, the sales data indexed with one of a plurality of customer IDs; receiving refund data from at least a second transaction node, the refund data indexed with one of the plurality of customer IDs; determining, based at least on the sales data and the refund data, a plurality of metric data sets indexed with one of the plurality of customer IDs, wherein the plurality of metric data sets includes at least a return amount data set, a return frequency data set, and a return rate data set; determining a plurality of statistical distributions for the plurality of metric data sets, wherein the return amount data set is fit to an exponential distribution, wherein the return frequency data set is fit to a Poisson distribution, and wherein the return rate data set is fit to a beta distribution; determining, for each of the plurality of statistical distributions, a risk threshold to produce a plurality of risk thresholds; determining, for each selected customer ID within the plurality of customer IDs and based at least on the plurality of risk thresholds, whether at least one metric value from the plurality of metric data sets, indexed with the selected customer ID, meets a corresponding risk threshold; and based at least on the metric value indexed with the selected customer ID meeting the corresponding risk threshold, reporting a risk transaction.

Alternatively, or in addition to the other examples described herein, examples include any combination of the following:
the first transaction node comprises at least one node selected from the list consisting of: a delivery vehicle, an online sales site, and an in-store terminal;
the second transaction node comprises at least one node selected from the list consisting of: a delivery vehicle, an online sales site, and an in-store terminal;
the return amount data set is fit to an exponential distribution;
the return frequency data set is fit to a Poisson distribution;
the return rate data set is fit to a beta distribution;
determining the risk threshold comprises determining, based on a secondary risk factor, the risk threshold, wherein the secondary risk factor comprises at least one factor selected from the list consisting of: a location of a transaction, a sales representative associated with a transaction, and an item included in a transaction;
the instructions are further operative to: train an ML model on transaction feedback data, wherein determining the risk threshold for each of the plurality of statistical distributions comprises determining, using the ML model, the risk threshold for each of the plurality of statistical distributions; and
training an ML model on transaction feedback data, wherein determining the risk threshold for each of the plurality of statistical distributions comprises determining, using the ML model, the risk threshold for each of the plurality of statistical distributions.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for anomaly identification and fraud detection, the system comprising:
a first transaction node;
a second transaction node;
a processor; and
a computer-readable medium storing instructions that are operative when executed by the processor to:
receive sales data from at least the first transaction node, the sales data indexed with one of a plurality of customer IDs;
receive refund data from at least the second transaction node, the refund data indexed with one of the plurality of customer IDs;
determine, based at least on the sales data and the refund data, a plurality of metric data sets indexed with one of the plurality of customer IDs, wherein the plurality of metric data sets includes at least a return amount data set, a return frequency data set, and a return rate data set;
determine a plurality of statistical distributions for the plurality of metric data sets, wherein the return amount data set, the return frequency data set, and the return rate data set are each fit to a different statistical distribution;
determine, for each of the plurality of statistical distributions, a risk threshold to produce a plurality of risk thresholds;
determine, for each selected customer ID within the plurality of customer IDs and based at least on the plurality of risk thresholds, whether at least one metric value from the plurality of metric data sets, indexed with the selected customer ID, meets a corresponding risk threshold; and
based at least on the metric value indexed with the selected customer ID meeting the corresponding risk threshold, report a risk transaction.

2. The system of claim 1 wherein the first transaction node comprises at least one node selected from the list consisting of:
a delivery vehicle, an online sales site, and an in-store terminal.

3. The system of claim 1 wherein the second transaction node comprises at least one node selected from the list consisting of:
a delivery vehicle, an online sales site, and an in-store terminal.

4. The system of claim 1 wherein the return amount data set is fit to an exponential distribution.

5. The system of claim 1 wherein the return frequency data set is fit to a Poisson distribution.

6. The system of claim 1 wherein the return rate data set is fit to a beta distribution.

7. The system of claim 1 wherein determining the risk threshold comprises determining, based on a secondary risk factor, the risk threshold, wherein the secondary risk factor comprises at least one factor selected from the list consisting of:
a location of a transaction, a sales representative associated with a transaction, and an item included in a transaction.

8. The system of claim 1 wherein the instructions are further operative to:
train a machine learning (ML) model on transaction feedback data, wherein determining the risk threshold for each of the plurality of statistical distributions comprises determining, using the ML model, the risk threshold for each of the plurality of statistical distributions.

9. A method of anomaly identification for fraud detection, the method comprising:
receiving sales data from at least a first transaction node, the sales data indexed with one of a plurality of customer IDs;
receiving refund data from at least a second transaction node, the refund data indexed with one of the plurality of customer IDs;
determining, based at least on the sales data and the refund data, a plurality of metric data sets indexed with one of the plurality of customer IDs, wherein the plurality of metric data sets includes at least a return amount data set, a return frequency data set, and a return rate data set;
determining a plurality of statistical distributions for the plurality of metric data sets, wherein the return amount data set, the return frequency data set, and the return rate data set are each fit to a different statistical distribution;
determining, for each of the plurality of statistical distributions, a risk threshold to produce a plurality of risk thresholds;
determining, for each selected customer ID within the plurality of customer IDs and based at least on the plurality of risk thresholds, whether at least one metric value from the plurality of metric data sets, indexed with the selected customer ID, meets a corresponding risk threshold; and
based at least on the metric value indexed with the selected customer ID meeting the corresponding risk threshold, reporting a risk transaction.

10. The method of claim 9 wherein the first transaction node comprises at least one node selected from the list consisting of:
a delivery vehicle, an online sales site, and an in-store terminal.

11. The method of claim 9 wherein the second transaction node comprises at least one node selected from the list consisting of:
a delivery vehicle, an online sales site, and an in-store terminal.

12. The method of claim 9 wherein the return amount data set is fit to an exponential distribution.

13. The method of claim 9 wherein the return frequency data set is fit to a Poisson distribution.

14. The method of claim 9 wherein the return rate data set is fit to a beta distribution.

15. The method of claim 9 wherein determining the risk threshold comprises determining, based on a secondary risk factor, the risk threshold, wherein the secondary risk factor comprises at least one factor selected from the list consisting of:
a location of a transaction, a sales representative associated with a transaction, and an item included in a transaction.

16. The method of claim 9 further comprising:
training a machine learning (ML) model on transaction feedback data, wherein determining the risk threshold for each of the plurality of statistical distributions comprises determining, using the ML model, the risk threshold for each of the plurality of statistical distributions.

17. One or more computer storage devices having computer-executable instructions stored thereon for anomaly identification and fraud detection, which, on execution by a computer, cause the computer to perform operations comprising:
receiving sales data from at least a first transaction node, the sales data indexed with one of a plurality of customer IDs;
receiving refund data from at least a second transaction node, the refund data indexed with one of the plurality of customer IDs;
determining, based at least on the sales data and the refund data, a plurality of metric data sets indexed with one of the plurality of customer IDs, wherein the plurality of metric data sets includes at least a return amount data set, a return frequency data set, and a return rate data set;
determining a plurality of statistical distributions for the plurality of metric data sets, wherein the return amount data set is fit to an exponential distribution, wherein the return frequency data set is fit to a Poisson distribution, and wherein the return rate data set is fit to a beta distribution;
determining, for each of the plurality of statistical distributions, a risk threshold to produce a plurality of risk thresholds;
determining, for each selected customer ID within the plurality of customer IDs and based at least on the plurality of risk thresholds, whether at least one metric value from the plurality of metric data sets, indexed with the selected customer ID, meets a corresponding risk threshold; and
based at least on the metric value indexed with the selected customer ID meeting the corresponding risk threshold, reporting a risk transaction.

18. The one or more computer storage devices of claim 17
wherein the first transaction node comprises at least one node selected from the list consisting of:
a delivery vehicle, an online sales site, and an in-store terminal; and
wherein the second transaction node comprises at least one node selected from the list consisting of:
a delivery vehicle, an online sales site, and an in-store terminal.

19. The one or more computer storage devices of claim 17 wherein determining the risk threshold comprises determining, based on a secondary risk factor, the risk threshold, wherein the secondary risk factor comprises at least one factor selected from the list consisting of:
a location of a transaction, a sales representative associated with a transaction, and an item included in a transaction.

20. The one or more computer storage devices of claim 17 wherein the operations further comprise:
training a machine learning (ML) model on transaction feedback data, wherein determining the risk threshold for each of the plurality of statistical distributions comprises determining, using the ML model, the risk threshold for each of the plurality of statistical distributions.
